(19) United States
(12) Patent Application Publication
(10) Pub. No.: US 2021/0221320 A1
(43) Pub. Date: Jul. 22, 2021

(54) AIRBAG WITH ELONGATED COUPLER

(71) Applicant: Mark A Steinbach, Clawson, MI (US)

(72) Inventor: Mark A Steinbach, Clawson, MI (US)

(21) Appl. No.: 16/746,156

(22) Filed: Jan. 17, 2020

(51) Int. Cl. B60R 21/232; B60R 21/213; B60R 21/2338

(52) U.S. Cl. CPC B60R 21/232; B60R 21/2338; B60R 21/213

(57) ABSTRACT

An airbag includes a body with a first end and a second end, with a length defined between the first end and the second end. A coupler is connected to the body and has a first end that is closer to the body first end than the body second end, a second end that is closer to the body second end than the body first end, and a length defined between the coupler first end and the coupler second end. The coupler has a first portion with a thickness and a second portion with a thickness measured perpendicular to the coupler length, and the second portion has a greater thickness than the first portion. Further, the second portion is located farther from the body than is the first portion, and the coupler extends at least 60% of the length of the body.

### FIELD

The present disclosure relates to an airbag having an elongated coupler that cooperates with a mount.

### BACKGROUND

Vehicles include airbags mounted to structural components of the vehicle behind interior trim panels. Some airbags, such as side curtain airbags, have a considerable length and may extend along all or a majority of the length of a vehicle passenger compartment. Mounting such airbags within the vehicle has been done with spaced apart brackets and separate fasteners. The long airbags can be somewhat unwieldy and may become twisted or otherwise oriented differently than preferred. Further, it is time consuming and can be difficult to secure the multiple fasteners which typically requires an operator to perform many operations at a relatively high height, for example, over the operator's head.

### SUMMARY

In at least some implementations, an airbag includes a body and a coupler. The body has a body first end and a body second end with a length defined between the body first end and the body second end. The coupler has a coupler first end that is closer to the body first end than the body second end, a coupler second end that is closer to the body second end than the body first end, and a length defined between the coupler first end and the coupler second end. The coupler is connected to the body and has a first portion with a thickness measured perpendicular to the coupler length, and a second portion with a thickness measured perpendicular to the coupler length, wherein the second portion has a greater thickness than the first portion. Further, the second portion is located farther from the body than is the first portion, and the coupler extends at least 60% of the length of the body.

In at least some implementations, one or both of the first portion and the second portion are continuous along the length of the coupler. The first portion may be connected to the body along the length of the first portion. In at least some implementations, the length of the coupler is the same as or within 10% of the same length of the body. The second thickness is at least twice the first thickness, and/or the second portion may define a free end of the coupler that is spaced from the airbag body.

In at least some implementations, a mount has a mount body with an opening extending from an opening first end to an opening second end. The opening is defined between two surfaces that are spaced apart at least as far as the thickness of the first portion and not as far as the thickness of the second portion. When the airbag is coupled to the mount, the second portion is adjacent to an opposite side of the opening than is the body of the airbag. In at least some implementations, the two surfaces that define the opening are continuous between the opening first end and the opening second end and wherein a length of the opening between the opening first end and the opening second end is at least 75% of the length of the coupler.

In at least some implementations, the mount defines a cavity, which may be a channel, track or other open area, that is open to the opening and the second portion is sized for receipt within the cavity with the first portion extending through the opening. In at least some implementations, the mount includes at least two pieces and one of the two surfaces is defined by a first piece of the at least two pieces and the other of the two surfaces is defined by a second piece of the at least two pieces. At least one of the first piece and the second piece may be part of a structural component of a vehicle body.

In at least some implementations, an airbag assembly includes an airbag and a mount. The airbag has a body with a body first end and a body second end and a length defined between the body first end and the body second end. The airbag also has a coupler having a coupler first end that is adjacent to the body first end and a coupler second end that is adjacent to the body second end with a length of the coupler defined between the coupler first end and the coupler second end. The coupler is connected to the airbag body and has a first portion with a thickness measured perpendicular to the coupler length, and a second portion with a thickness measured perpendicular to the coupler length, wherein the second portion has a greater thickness than the first portion. Further, the second portion is located farther from the body than is the first portion, and the coupler extends at least 60% of the length of the body. The mount has a mount body with an opening extending from an opening first end to an opening second end. The opening is defined between two surfaces that are spaced apart at least as far as the thickness of the first portion and not as far as the thickness of the second portion. When the airbag is coupled to the mount, the second portion is adjacent to an opposite side of the opening than is the body of the airbag.

In at least some implementations, the two surfaces that define the opening are continuous between the opening first end and the opening second end and a length of the opening between the opening first end and the opening second end is at least 75% of the length of the coupler. In at least some implementations, one or both of the first portion and the second portion are continuous along the length of the coupler. The length of the coupler may be the same as or within 10% of the same length of the body. The second thickness may be at least twice the first thickness. And the second portion may define a free end of the coupler that is spaced from the body.

In at least some implementations, the mount defines a cavity that is open to the opening and the second portion is sized for receipt within the cavity with the first portion extending through the opening. In assembly, the second portion of the coupler is within the cavity and the airbag body is outside of, or not within, the cavity, and a retention surface may extend between at least part of the second portion of the coupler and the airbag body.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a portion of a vehicle body showing an airbag installed adjacent to a roof rail of the body;

FIG. 2 is an enlarged, fragmentary perspective view showing the airbag connected to a mount;

FIG. 3 is an exploded perspective view showing a portion of a coupler for the airbag and a portion of the mount;

FIG. 4 is a perspective view of two plates that may define part of a vehicle structure or frame and which define a mount for the airbag;

FIG. 5 is an enlarged, fragmentary perspective view of the plates shown in FIG. 4 with a coupler for an airbag received in the mount;

FIG. 6 is an enlarged, fragmentary perspective view of two plates similar to those shown in FIG. 4 and which define an alternate mount;

FIG. 7 is a perspective view of a plate that may define part of a vehicle structure or frame and which defines a mount for the airbag; and

FIG. 8 is an enlarged, fragmentary perspective view of the plate of FIG. 7 showing a section of the mount.

### DETAILED DESCRIPTION

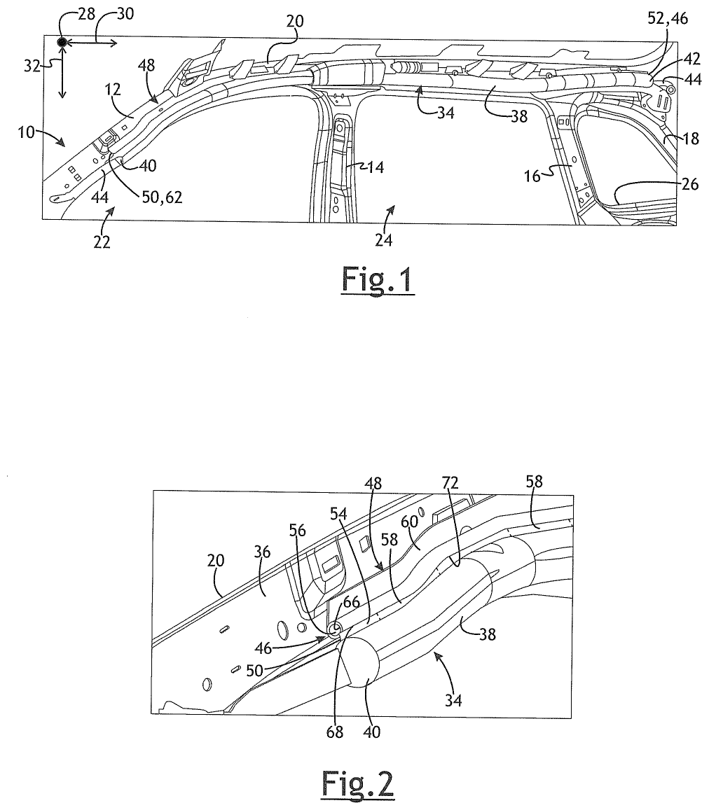

Referring in more detail to the drawings, FIG. 1 illustrates a portion of a vehicle body 10, sometimes called a body-in-white, that includes structural members for mounting various vehicle components like doors, windows and the like. The portion shown in FIG. 1 is an inside surface of a passenger side of the vehicle which includes spaced apart A, B, C, and D pillars 12, 14, 16 and 18, respectively, coupled to or integrally formed with and extending from a horizontal roof rail 20. A passenger side front door opening 22 is located between the A and B pillars 12, 14, a passenger side rear door opening 24 is between the B and C pillars 14, 16, and a rear window opening 26 is between the C and D pillars 16, 18. The driver side of the body 10 may be a mirror image of the passenger side with the same arrangement of pillars and openings. The passenger and driver side of the body 10 are spaced apart in a cross-car direction indicated by point 28 in FIG. 1 (direction is perpendicular to the page in FIG. 1). A front and a rear of the vehicle (the front is closer to the A pillar 12 than is the rear, and the rear is closer to the D pillar 18 than is the front) are spaced apart in a fore-aft direction that is perpendicular to the cross-car direction and indicated by arrow 30 in FIG. 1. And the vehicle has a roof, part of which may be defined by the roof rail 20, and a floor spaced from the roof in a vertical direction that is perpendicular to both the fore-aft and cross-car directions and indicated by arrow 32 in FIG. 1.

The interior or inwardly facing side of the pillars 12-18, roof rail 20 and other structural components of the body 10 are typically covered by trim pieces that have an inwardly facing surface that defines part of a passenger compartment of the vehicle. The trim pieces may include, for example, a headliner that covers the roof and pillar cappings that overlie the pillars 12-18 and extend from door panels to the headliner. Certain components of the vehicle may be mounted between the trim pieces and the body, such as one or more airbags.

FIG. 1 shows an airbag 34 that extends along the roof rail 20, from the A-pillar 12 to the D-pillar 18 of the vehicle body 10. This type of airbag commonly is called a side curtain or Side AirBag Inflatable Curtain (SABIC), although the innovations described herein may be used with other airbags. The airbag 34 as shown in FIGS. 1 and 2 is in its first, or not deployed state and is generally rolled or folded and received against the inboard or inwardly facing side 36 of the roof rail 20, at or above the upper end of the pillars. In this location, the airbag 34 generally is not visible to passengers within the passenger compartment as it is located behind the interior trim pieces.

The airbag 34 has a body 38 with a first end 40 closer to the front of the vehicle than a second end 42 which is closer to the rear of the vehicle than the first end 40. The body 38 may be defined of any suitable material and defines an interior in which a gas may be received to inflate the body 38 to its second or deployed state in which the body 38 moves outwardly into the passenger compartment where it may be located between one or more passengers in the vehicle and the vehicle pillars, doors and/or windows. The airbag 34 may include one or more tethers 44 connected to the body 38 and to the vehicle body 10, generally at one or both of the first end and second end of the body 38. The tethers 44 limit travel of the airbag 34 as the airbag 34 is deployed, to provide a desired movement of the airbag 34 and/or position the airbag 34 in a desired location within the vehicle when deployed.

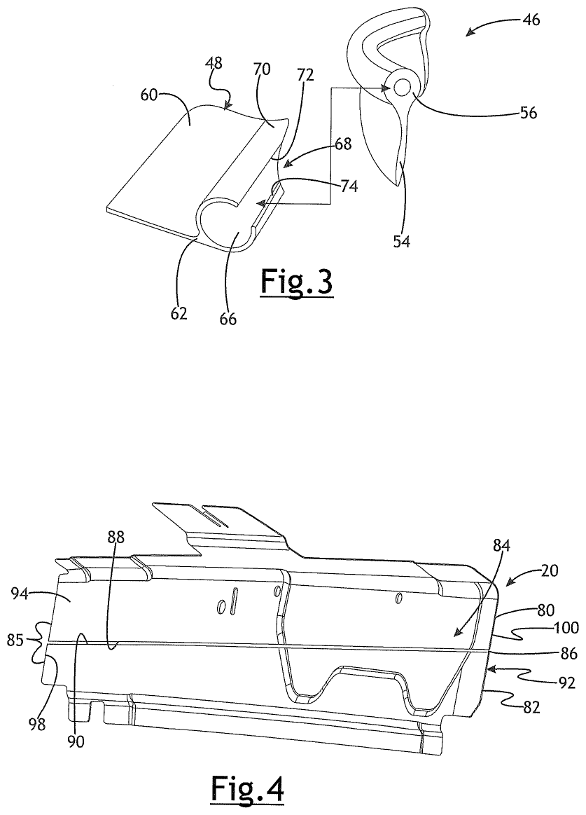

As shown in FIGS. 1-3, to facilitate securely mounting the airbag 34 to the vehicle, the airbag 34 may also include or be connected to a coupler 46. The coupler 46 is elongated in that it extends along a significant portion or all of the length of the airbag body 38 and is adapted to be received in a mount 48 that is part of or fixed to the vehicle body. The coupler 46 has a first end 50 that is closer to the body first end 40 than the body second end 42, and the coupler 46 has a second end 52 that is closer to the body second end 42 than the body first end 40. The coupler 46 has a length defined between the coupler first end 50 and the coupler second end 52. And the coupler 46 has a first portion 54 that is connected to the airbag body 38 and a second portion 56 that is coupled to the first portion 54 and spaced from the airbag body 38. In at least some implementations, the coupler 46 extends between 60% and 100% of the length of the airbag body 38, although the coupler 46 may be longer than the airbag body 38, if desired.

The first portion 54 may be continuous along the length of the coupler 46, or the first portion 54 may be defined by discrete sections with spaced between the sections, as desired. In FIG. 2, the areas 58 that are between dashed lines indicate sections of the first portion 54 that could be removed if a discontinuous or segmented first portion 54 is desired. The removed/open areas 58 between sections of the first portion 54 could have any desired shape and size and spacing. The second portion 56 may be continuous along the length of the coupler 46 or may be defined in one or more sections. As will be described in more detail below, if the second portion 56 is continuous along its length, assembly of the airbag 34 within the vehicle may be facilitated, but other embodiments may be used. The first portion 54 has a thickness measured perpendicular to the coupler length that is less than the thickness of the second portion 56 (also measured perpendicular to the coupler length). The first portion 54 may have a height measured between the airbag body 38 and the second portion 56, and the second portion 56 may be located spaced from the airbag body 38 with the first portion 54 between the second portion 56 and the airbag body 38. The second portion 56 may define a free end of the coupler 46.

To secure the airbag 34 to the vehicle, the mount 48 is arranged to cooperate with the coupler 46 and hold the coupler 46 in place relative to the vehicle. The mount 48 may be defined by a member separate from the structural components of the vehicle (e.g. the roof rail 20 and/or pillars), as shown in FIGS. 1 and 2, or by one or more plates, pieces or other parts of the vehicle body, as shown in FIGS. 4-8.

In at least some implementations, such as is shown in FIGS. 1 and 2, the mount 48 includes a body 60 that is secured to the vehicle, such as by one or more fasteners received through openings in the mount body 60 and secured to the roof rail 20. The mount 48 may have a length between a first end 62 and second end 64 that is the same as, less than or greater than the length of the coupler 46. The mount body 60 includes a cavity 66 that is open at the first end 62 of the mount body 60 and which extends toward the second end 64 and which may be open at the second end 64 of the mount body 60 as well, if desired. The cavity 66 may have any desired shape and size, may be formed in or defined by a channel, track or other body, or simply be an open space adjacent to a body, and is arranged to receive therein the second portion 56 of the coupler 46. In the example shown, the cavity 66 is generally cylindrical and is circumferentially continuous or complete except for an opening 68 provided in the mount body, although other voids could be provided, if desired. The second portion 56 may be shaped complementarily to the cavity 66 or differently shaped, as desired.

The opening 68 in the mount 48 extends through a wall 70 of the mount body 60 and into the cavity 66 and may be defined by two surfaces 72, 74 of the mount body 60 on either side of the opening 68. The opening 68 may extend the length of the cavity 66 and may be continuous (e.g. from the first end 62 to the second end 64). The opening 68 has a width that is less than the width of the cavity 66, and is arranged so that the first portion 54 of the coupler 46 extends through the opening 68 in assembly, but the second portion 56 of the coupler 46 is larger/wider than and does not fit in the opening 68. So arranged, the second portion 56 of the coupler 46 is within the cavity 66, the first portion 54 of the coupler 46 extends through the opening 68 to the airbag body 38 which is outside of the cavity 66. The second portion 56 is retained by the mount body 60 that defines, or mount bodies 60 that define, the cavity 66. At least one surface of the mount body 60 may define a retention surface that is engaged by the second portion 56 of the coupler 46 and which is between the second portion 56 of the coupler 46 and the airbag 34 when the airbag 34 is installed on the mount 48.

In at least some implementations, the mount 48 is the same length as the coupler 46 or within 30% of the length of the coupler 46. The two surfaces 72, 74 that define the opening 68 may be continuous between the opening's first end (e.g. at mount first end 62) and the opening's second end (which may be at the mount second end 64). A length of the opening 68 between the opening's first end and the opening's second end may be at least 75% of the length of the coupler 46. The mount 48 may be formed from one piece or multiple pieces and the length noted herein is the collective length of all pieces of the mount.

The second portion 56 of the coupler 46 is sufficiently firm or rigid such that the second portion 56 remains in the cavity 66 even when the airbag 34 is deployed. That is, the force of the airbag deployment is not sufficient to pull the second portion 56 through the opening 68. Further, the first portion 54 is firmly secured to the airbag body 38 such that the first portion 54 remains fully or at least partially intact when the airbag 34 is deployed. In this way, the airbag 34 remains coupled to the mount 48 even after the airbag 34 is deployed. This facilitates, for example, providing a desired positioning of the airbag 34, and/or a desired path or mode of deployment of the airbag 34.

To assemble the airbag 34 to the mount 48, the second end 52 of the second portion 56 of the coupler 46 is aligned with and inserted into the passage at the first end 62 of the mount 48. The airbag 34 and coupler 46 are then slid or pulled toward the second end 64 of the mount 48, with the first portion 54 sliding along one or both surfaces 72, 74 that define the opening 68 and the second portion 56 sliding within the cavity 66. In doing so, the airbag 34 is properly oriented with respect to the mount 48, and hence, the vehicle, and twisting or other contortions of the airbag 34 are prevented in the installed position of the airbag 34. When the second portion 56 of the coupler 46 and the mount 48 are continuous along their lengths, only a single alignment and insertion of the second portion 56 into the cavity 66 is needed, and the proper alignment and connection of the airbag 34 along the length of the second portion 56 can be assured. Even if one or both of the second portion 56 and the mount 48 are not continuous, the separate alignment and insertion steps that would be needed to insert the sections of the second portion 56 into the cavity 66, the second portion 56 into each cavity 66 of a multiple section mount 48, or the sections of the second portion 56 into each cavity 66 of a multiple section mount 48 are easy to perform and readily visually detectable when completed. Further, the multiple steps still ensure alignment of the airbag 34 relative to the mount(s) 48 and vehicle as the coupler 46 is secured to a desired portion of the airbag 34 and the coupler 46 desirably fits into the mount 48 in one orientation.

Previously, multiple separate brackets were used to mount such airbags to the vehicle, the brackets were of short length and separated by a distance significant enough that the airbags could become twisted and/or partially unfolded and incorrectly aligned or attached to the brackets. Further, attaching long airbags, such as that shown in FIG. 1, to multiple brackets required multiple separate fastening operations and required an operator to move in and out of the vehicle (e.g. in the front door opening to fasten the airbag to brackets near the front of the vehicle, and then to the rear door opening to fasten brackets near the rear of the vehicle). Further, the multiple fastening operations might not all be done properly, for example, some brackets may be missed or some fasteners not fully inserted to a desired torque.

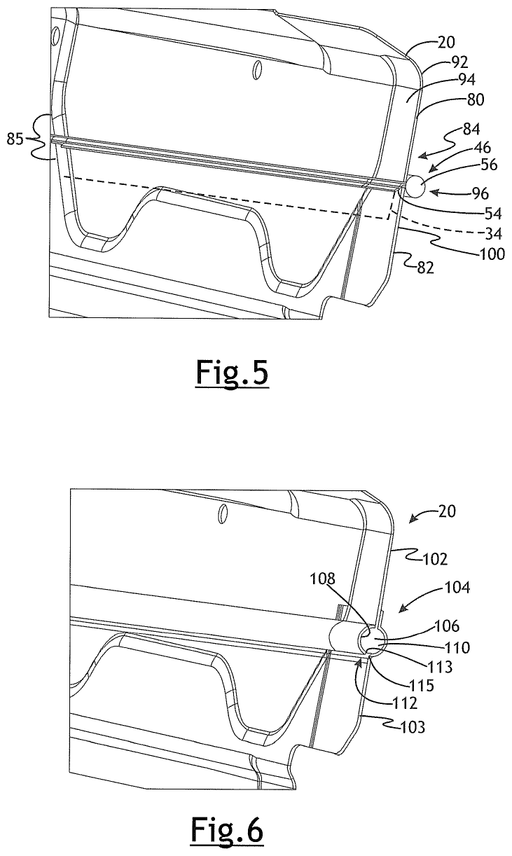

FIG. 4 illustrates an implementation in which a portion of a roof rail 20 or other vehicle structural component that includes two pieces or plates 80, 82 defines a mount 84 which may be used to secure the airbag 34 in place. The plates 80, 82 define a mount body 85 and are separated from each other by an opening 86 of the mount 84 that is defined by opposed/adjacent surfaces 88, 90 of the plates 80, 82, respectively. FIG. 5 illustrates a coupler 46 assembled to the mount 84, with the second portion 56 received adjacent to one side of the two plates 80, 82, for example an outer surface 92 of the plates 80, 82 that faces toward the exterior of the vehicle, and the first portion 54 extending through the opening 86. The airbag 34 (shown diagrammatically by dashed lines in FIG. 5) would be fastened to the first portion 54 of the coupler 46 on the opposite side of the plates 80, 82 as the second portion 56, for example, adjacent to an inner surface 94 of the plates 80, 82 that faces toward the passenger compartment or interior of the vehicle. The opening 86 may be arranged like the opening 68 of the mount 48 described above, and so that at least part of the second portion 56 of the coupler 46 does not fit through the opening 86 under the forces encountered when the airbag 34 deploys. In this example, the cavity 96 exists behind the two plates 80, 82 that define the opening 86, and the retention surface is defined by the outer surface 92 of one or both plates 80, 82 in the area adjacent to the opening 86 and overlapped by the second portion 56 of the coupler 46.

Assembly of the airbag 34 is similar to that described above in that the first portion 54 is aligned with the opening 86 at a first end 98 of the mount 84, with the second portion 56 aligned with the cavity 96 or open area behind the plates 80, 82. Then, the airbag 34 is moved toward a second end 100 of the mount 84 and the first portion 54 slides along one or both surfaces 88, 90 that define the opening 86. The two plates 80, 82 would be securely held in place by being coupled to other portions of the vehicle and/or to each other, behind the opening 86 and not interfering with the installation of the coupler 46 in the mount 84 and opening 86. The plates 80, 82 may be the full length of the airbag 34 and/or coupler 46, or the mount 84 may be defined in additional plates aligned lengthwise to provide a mount 84 of a desired length. When the coupler 46 is received in the mount 84, the airbag 34 is firmly secured to the vehicle and in a desired orientation and location.

FIG. 6 illustrates an implementation in which a portion of a roof rail 20, or other vehicle structural component that includes two pieces or plates 102, 103, defines a mount 104 with a mount body 105. In this example, each plate 102, 103 defines part of a cavity 106 which may be defined between oppositely facing surfaces 108, 110 of the plates 102, 103. In the example shown, the plates 102, 103 include curved portions defined by part of the outer surface 108 of the first plate 102 and the inner surface 110 of the second plate 103. Together, the plates 102, 103 define the cavity 106 which may be similar in size and shape to the cavity 66 in the implementation of FIGS. 1 and 2, if desired, and arranged to receive therein the second portion 56 of the coupler 46. The plates 102, 103 are separated from each other by an opening 112 defined by opposed/adjacent surfaces 113, 115 of the plates 102, 103. The opening 112 communicates with and is open to the cavity 106, and may be arranged as described above with a size to receive therein the first portion 54 of the coupler 46 but to prevent at least part of the second portion 56 of the coupler 46 from being pulled therethrough. The plates 102, 103 may be the full length of the airbag 34 and/or coupler 46, or the mount 104 may be defined in additional plates aligned lengthwise to provide a mount 104 of a desired length. In this example, the cavity 106 exists between the two plates 102, 103, and the retention surface is defined by the surfaces of one or both plates 102, 103 that define the cavity 106 and which are overlapped by the second portion 56 of the coupler 46. In the example shown in FIG. 6, the cavity 106 is arranged with the first plate 102 defining an inwardly extending portion of the cavity 106 and the second plate 103 defining an outwardly extending portion of the cavity 106, and the retention surface may be defined by the first plate 102 (e.g. the second portion 56 of the coupler 46 is pulled into the first plate 102 upon deployment of the airbag 34).

Assembly of the airbag 34 in this implementation is like that described above with regard to the implementation shown in FIGS. 1 and 2. The cavity 106 could instead be formed in just one plate, such as by drawing or otherwise forming (e.g. by extrusion) a portion of the plate into a cylindrical form or other shape that includes an opening 112. That is, the cylinder would not be complete so that the second portion 56 could be received within the cavity 106 and the first portion 54 could extend through the opening 112.

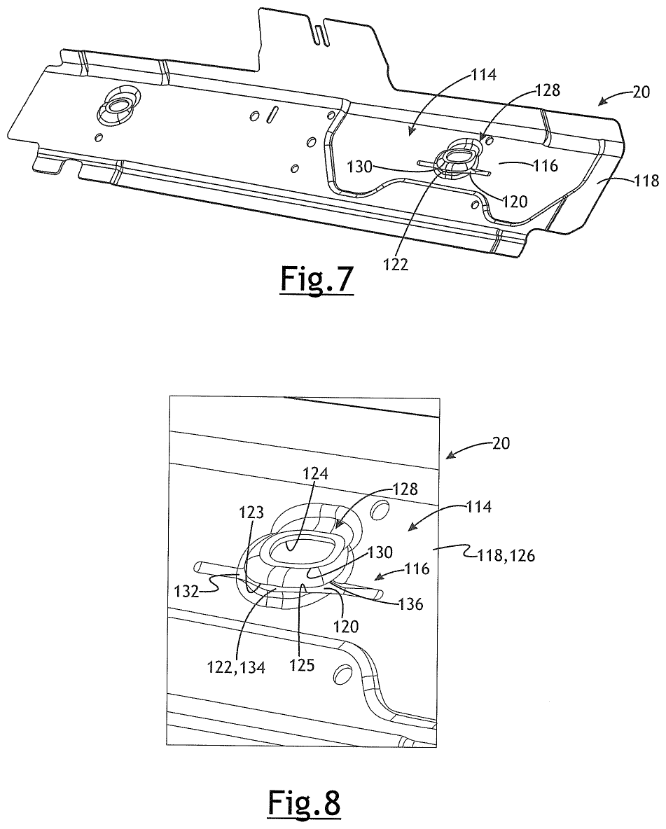

FIGS. 7 and 8 illustrate a mount 114 having a mount body 116 defined in a portion of a roof rail 20 or other vehicle structural component that includes one piece or plate 118 that defines the mount 114. The mount 114 in this example is not continuous and is instead defined by discrete sections of the plate 18 that each include or define a cavity 120 or other void in the plate 118. Each of the sections of the plate 118 also has as opening 122 that is open to the cavity 120. The openings 122 are each defined by two surfaces 123, 125 of the plate 118 and each opening 122 has a thickness or width that is less than that of the cavity 120. The cavity 120 in each section is arranged to slidably receive therein the second portion 56 of the coupler 46, while the first portion 54 of the coupler 46 slides between the two surfaces and within the opening 122. In at least some implementations, the second portion 56 may be received adjacent to an outer surface 124 of the plate 118, for example, facing toward the exterior of the vehicle. The airbag 34 would be received and positioned on the opposite side of the plate 118 as the second portion 56 of the coupler 46, for example, adjacent to an inner surface 126 of the plate 118 that faces toward the passenger compartment or interior of the vehicle.

In the example shown, the mounts 114 are defined in sections of the plate 118 that include an opening 122 to receive a fastener through the plate 118. The opening 122 may be defined in part by a socket 128 and a flange 130 that may define part of the socket 128 and extend outwardly from a main section of the plate 118. As shown in FIG. 8, the opening 122 includes an enlarged inlet 132 sized to receive therethrough the second portion 56 of the coupler 46 and a smaller size (e.g. smaller width) main portion 134 open to the inlet 132 and extending therefrom. The opening 122 may similarly include an enlarged outlet 136 at an end of the opening 122 and out of which the second portion 56 may pass when the airbag 34 is installed on the plate 118. Such an outlet 134 is needed only when the coupler 46 extends out of or beyond that opening 122 which is not required (e.g. at the end of the coupler 46).

In the example shown, the socket 128, or the flange 130 adjacent thereto, extends away from the inner surface 126 of the plate 118, toward the passenger compartment of the vehicle, although other arrangements may be used. While the sections defining the mount 114 are less than 50% of the length of the plate 118, the openings 122 could be longer, if desired, including extending along the full length of the plate 118. Such an opening 122 could be formed, for example, by a flange 130 that extends lengthwise (e.g. in the direction between the two ends of the plate 118) any desired length. In any event, aligning the second portion 56 with each mount 114 or mount section ensures that the airbag 34 is securely coupled to the vehicle and located in a desired orientation and position. Further, that the coupler 46 is secured to each mount 114 or section of the mount 114 is easily visually confirmed to reduce improper or incomplete installations and ensure a desired connection of the airbag 34 to the vehicle. In this example, the cavity 120 exists behind the plate 118, the opening 122 is open to the back or outer surface 124 of the plate 118, and the retention surface is defined by the outer surface 124 of the plate 118 in the area adjacent to the opening 122 and overlapped by the second portion 56 of the coupler 46.

In assembly, the first end of the second portion 56 of the coupler 46 is initially aligned with the first end of the opening 122 closest to the first end of the plate 118 (recognizing that there might be only one opening), and the airbag 34 is moved relative to the plate 118 to slide the first portion 54 of the coupler 46 within the opening 122 of that mount(s) 114 or section of the mount 114. Then, the first end of the second portion 56 is aligned with openings 122 of successive mounts or sections of the mount and the airbag 34 is moved to move the coupler 46 relative to the plate 118 and secure the coupler 46 to each mount 114.

Accordingly, the airbag 34 is securely connected to a coupler 46 that extends along a significant portion of the length of the airbag 34 and which is retained within a mount. The assembly of the coupler 46 to the mount ensures a proper orientation and location of the airbag 34, inhibits or prevents twisting of the airbag 34 during installation, enables visual confirmation of proper airbag installation, and does not require driving of a plurality of separate fasteners spaced along the length of the airbag 34.

What is claimed is:

1. An airbag, comprising:
a body having a body first end and a body second end with a length defined between the body first end and the body second end, and
a coupler having a coupler first end that is closer to the body first end than the body second end, and a coupler second end that is closer to the body second end than the body first end, the coupler having a length defined between the coupler first end and the coupler second end, the coupler being connected to the body and having a first portion with a thickness measured perpendicular to the coupler length, and a second portion with a thickness measured perpendicular to the coupler length, and wherein the second portion has a greater thickness than the first portion, the second portion is located farther from the body than is the first portion, and the coupler extends at least 60% of the length of the body.

2. The airbag of claim 1 wherein one or both of the first portion and the second portion are continuous along the length of the coupler.

3. The airbag of claim 2 wherein the first portion is connected to the body along the length of the first portion.

4. The airbag of claim 1 wherein the length of the coupler is the same as or within 10% of the same length of the body.

5. The airbag of claim 1 wherein the second thickness is at least twice the first thickness.

6. The airbag of claim 1 wherein the second portion defines a free end of the coupler that is spaced from the body.

7. The airbag of claim 1 which also includes a mount having a mount body with an opening extending from an opening first end to an opening second end, the opening defined between two surfaces that are spaced apart at least as far as the thickness of the first portion and not as far as the thickness of the second portion, wherein when the airbag is coupled to the mount, the second portion is adjacent to an opposite side of the opening than is the body of the airbag.

8. The airbag of claim 7 wherein the two surfaces that define the opening are continuous between the opening first end and the opening second end and wherein a length of the opening between the opening first end and the opening second end is at least 75% of the length of the coupler.

9. The airbag of claim 7 wherein the mount defines a cavity that is open to the opening and wherein the second portion is sized for receipt within the cavity with the first portion extending through the opening.

10. The airbag of claim 7 wherein the mount includes at least two pieces and one of the two surfaces is defined by a first piece of the at least two pieces and the other of the two surfaces is defined by a second piece of the at least two pieces.

11. The airbag of claim 10 wherein at least one of the first piece and the second piece are part of a structural component of a vehicle body.

12. An airbag assembly, comprising:
an airbag having a body with a body first end and a body second end and a length defined between the body first end and the body second end, and the airbag has a coupler having a coupler first end that is adjacent to the body first end and a coupler second end that is adjacent to the body second end with a length of the coupler defined between the coupler first end and the coupler second end, the coupler being connected to the body and having a first portion with a thickness measured perpendicular to the coupler length, and a second portion with a thickness measured perpendicular to the coupler length, and wherein the second portion has a greater thickness than the first portion, the second portion is located farther from the body than is the first portion, and the coupler extends at least 60% of the length of the body; and
a mount having a mount body with an opening extending from an opening first end to an opening second end, the opening defined between two surfaces that are spaced apart at least as far as the thickness of the first portion and not as far as the thickness of the second portion, wherein when the airbag is coupled to the mount, the second portion is adjacent to an opposite side of the opening than is the body of the airbag.

13. The assembly of claim 12, wherein the two surfaces that define the opening are continuous between the opening first end and the opening second end and wherein a length of the opening between the opening first end and the opening second end is at least 75% of the length of the coupler.

14. The assembly of claim 12 wherein the mount defines a cavity that is open to the opening and wherein the second portion is sized for receipt within the cavity with the first portion extending through the opening.

15. The assembly of claim 12 wherein one or both of the first portion and the second portion are continuous along the length of the coupler.

16. The assembly of claim 12 wherein the length of the coupler is the same as or within 10% of the same length of the body.

17. The assembly of claim 12 wherein the second thickness is at least twice the first thickness.

18. The assembly of claim 12 wherein the second portion defines a free end of the coupler that is spaced from the body.
